(19) United States
(12) Patent Application Publication
(10) Pub. No.: US 2020/0102255 A1
(43) Pub. Date: Apr. 2, 2020

(54) NEW METHOD FOR FERTILIZING AGRICULTURAL SOIL

(71) Applicant: BASF SE, Ludwigshafen am Rhein (DE)

(72) Inventors: Ching Feng, Research Triangle Park, NC (US); Jeremie Miller, Research Triangle Park, NC (US); Kyle Edward Keller, Research Triangle Park, NC (US)

(21) Appl. No.: 16/621,733

(22) PCT Filed: Jun. 5, 2018
(86) PCT No.: PCT/EP2018/064764

§ 371 Date: Dec. 12, 2019

(30) Foreign Application Priority Data
Jun. 14, 2017 (EP) 17175945.9

(51) Int. Cl. A01C 21/00; C05G 3/00; C05C 3/00; C05C 1/00; C05C 9/00; A01C 23/02

(52) U.S. Cl. CPC C05G 3/08; C05G 3/0064; C05C 3/00; A01C 23/024; C05C 9/00; A01C 21/00; C05C 1/00

(57) ABSTRACT

Provided herein is a method for fertilizing agricultural soil by applying at least one fertilizer N to the soil, wherein the at least one fertilizer N is applied in combination with a formulation F. The formulation F comprises at least one nitrification inhibitor I and at least one organic solvent S, and the at least one solvent S is selected from ethylene glycol, propylene glycol, diethylene glycol, dipropylene glycol, diglyme, fatty acid dialkylamides, benzyl alcohol, butyrolactone, propylene carbonate, ethyl hexyl lactate, 2-butoxy ethanol, dimethylsulfoxide, or mixtures thereof. The formulation F is essentially free from 3,4-dimethylpyrazolphosphate.

The present invention is related to a method for fertilizing agricultural soil by applying at least one fertilizer N to said soil, wherein said at least one fertilizer N is applied in combination with a formulation F, said formulation F comprising at least one nitrification inhibitor I and at least one organic solvent S, wherein said at least one nitrification inhibitor I is 3,4-dimethyl-1-H-pyrazole, and wherein said at least one solvent S is selected from ethylene glycol, propylene glycol, diethylene glycol, dipropylene glycol, diglyme, fatty acid dialkylamides, benzyl alcohol, butyrolactone, propylene carbonate, ethylhexyllactate, 2-butoxy ethanol, dimethylsulfoxide or mixtures thereof, and wherein said formulation F is essentially free from 3,4-dimethylpyrazolphosphate.

Nitrification of nitrogen containing compounds is a phenomenon that reduces the efficiency of fertilization of soil with nitrogen containing compounds.

Through nitrification, N-containing compounds are decomposed by bacteria. Thereby, the nitrogen contained therein is oxidized and is no longer available for takeup by the crops.

One common approach to reduce nitrification is to apply nitrification inhibitors to the soil.

US 2003/14561 discloses the use of pyrazoles like 3,4-dimethylpyrazole (DMP) as nitrification inhibitors.

WO 2017/069828 discloses formulations of nitrification inhibitors with solvent mixtures and corrosion inhibitors.

WO 2015/81116 discloses formulations of nitrification/urease inhibitors in organic liquid solvating systems comprising a mixture of aprotic solvents.

There is a need for formulations of nitrification inhibitors that can be used with a broad range of fertilizers and for methods of applying such formulations in combination with fertilizers, for example with anhydrous ammonia.

It was one objective of the present invention to provide formulations of nitrification inhibitors that are stable at the low temperatures as they occur in the application of anhydrous ammonia and to provide methods for applying such formulations.

This objective was achieved by a method for fertilizing agricultural soil by applying at least one fertilizer N to said soil, wherein said at least one fertilizer N is applied in combination with a formulation F, said formulation F comprising at least one nitrification inhibitor and at least one organic solvent S, and

wherein said at least one solvent S is selected from ethylene glycol, propylene glycol, diethylene glycol, dipropylene glycol, diglyme, fatty acid dialkylamides, benzyl alcohol, butyrolactone, propylene carbonate, ethyl hexyl lactate, 2-butoxy ethanol, dimethylsulfoxide (DMSO) or mixtures thereof, and wherein said formulation F is essentially free from 3,4-dimethylpyrazolphosphate.

In relation to 3,4-dimethylpyrazolphosphate (referred to as “DMPP” in the following), “essentially” shall mean that the amount of DMPP (expressed in weight percent) in the formulation F is preferably not more than 3 weight percent (referred to as “wt.-%” in the following), more preferably not more than 1 wt.-%, most preferably not more than 0.3 wt.-%, particularly preferably not more than 0.1 wt.-%, particularly more preferably not more than 0.03 wt.-%, particularly most preferably not more than 0.01 wt.-%, for example preferably not more than 0.003 wt-%, for example more preferably not more than 0.001 wt.-%, for example most preferably not more than 0.0003 wt.-%, for example not more than 0.0001 wt.-%.

“Agricultural soil” shall mean the soil on which crops are grown. In the context of this application, the terms “soil” and “turf” shall mean “agricultural soil” as referred to in the claims.

According to the invention, a formulation F is applied to the soil in combination with a fertilizer N.

Formulation F comprises a nitrification inhibitor I.

Nitrification inhibitor I can in principle be any compound capable of reducing the activity of bacteria in the nitrification process.

Preferably, nitrification inhibitor I is selected from pyrazoles like 3,4-dimethyl-1-H-pyrazole (DMP), 2-Chloro-6-(trichloromethyl)pyridine (Nitrapyrin), dicyandiamide, ammoniumthiosulfate, or mixtures thereof.

Preferably nitrification inhibitor in selected from nitrapyrin, DMP or mixtures thereof.

Especially preferably, nitrification inhibitor I is DMP.

As it turned out, the use of salts of DMP and phosphoric acid (3,4-dimethylpyrazol phosphate, also referred to as DMPP) results in reduced stability of formulations F, especially when used with anhydrous ammonia. Thus, formulations F comprise DMPP in amounts of less than 5% by weight relative to the total amount of nitrification inhibitors I. Preferably, formulations F comprise less than 1% by weight of DMPP relative to the total amount of nitrification inhibitors I. Especially preferably formulations F comprise essentially no or no DMPP.

Organic solvent S (also referred to as solvent S) is selected from ethylene glycol, propylene glycol, diethylene glycol, dipropylene glycol, diglyme, fatty acid dialkylamides (e.g. C₈/C₁₀ fatty acid dimethylamide), benzyl alcohol, butyrolactone, propylene carbonate, ethyl hexyl lactate, 2-butoxy ethanol, DMSO or mixtures thereof.

Preferably solvent S is selected from propylene glycol, benzyl alcohol, butyrolactone and fatty acid dialkylamides.

Especially preferably solvent S is propylene glycol.

In one embodiment, formulation F comprises DMP and propylene glycol.

Normally, formulation F comprises 5 to 50 parts by weight of a nitrification inhibitor I and 50 to 95 parts by weight of solvent S.

Preferably, formulation F comprises 35 to 45 parts by weight of a nitrification inhibitor I and 55 to 65 parts by weight of solvent S.

In one embodiment, formulation F comprises 5 to 50 parts by weight of DMP and 50 to 95 parts by weight of propylene glycol.

In one embodiment, formulation F comprises 35 to 45 parts by weight of DMP and 55 to 65 parts by weight of propylene glycol.

In one embodiment, formulation F consist essentially of at least one nitrification inhibitor I and at least one organic solvent S.

In one embodiment formulation F consists of at least one nitrification inhibitor I and at least one organic solvent S.

In one embodiment formulation F consists of DMP and at least one organic solvent S, preferably propylene glycol.

It is possible that formulation F in addition comprises further additives, such as corrosion inhibitors or dispersants.

According to the invention, formulations F are applied to the soil in combination with at least one fertilizer N.

Fertilizers N can in principle be any nitrogen containing fertilizer.

For example, fertilizer N can be selected from anhydrous ammonia, urea, manure, ammonium nitrate, UAN (urea ammonium nitrate), mono ammonium phosphates, diammonium phosphates, organic fertilizers or mixtures thereof.

Such nitrogen containing fertilizers are often used in combination with other types of fertilizers, such as phosphorous containing fertilizers or potassium containing fertilizers.

In one preferred embodiment, fertilizer N is anhydrous ammonia or UAN.

In one especially preferred embodiment, fertilizer N is anhydrous ammonia.

“Liquid ammonia” is often also referred to as “anhydrous ammonia”, since it is not applied as an aqueous solution, but rather as liquified ammonia that contains no or only small amounts of water that have condensed in the liquid ammonia from the air. Normally the amount of water in “anhydrous ammonia” upon its application to the soil is below 1% by weight based on the ammonia. Liquid Ammonia is normally stored in a pressurized container.

According to the invention, formulation F is applied to the soil in combination with fertilizer N. “In combination” in context shall mean that formulation F and fertilizer N are applied to the soil simultaneously or with a time span of no more than 14 days, preferably no more than 7 days or 3 days.

Preferably, formulation F and fertilizer N are applied to the soil simultaneously. “Simultaneously” in this context means that formulation F and fertilizer N are mixed before being applied to the soils or that they are applied within a time span of less than 30 seconds, preferably less than 10 seconds, for example through separate application nozzles.

The application of formulation F and fertilizer N can for example be by spraying or, especially in the case of anhydrous ammonia, by injection in the soil and optionally knifing.

In one embodiment, formulation F and fertilizer N are applied to the soil by a device that is physically connected to a container comprising formulation F and to another container comprising fertilizer N, preferably in liquid form, especially anhydrous ammonia.

In one embodiment, formulation F and fertilizer N are applied to the soil by a device that is physically connected to a container comprising formulation F and to another container comprising fertilizer N, preferably in liquid form, especially preferably anhydrous ammonia, wherein formulation F and fertilizer N are continuously mixed during the application in a mixing device, for example a mixing chamber, and wherein the so obtained mixture of formulation F and fertilizer N is then applied to the soil by through a nozzle (“inline mixing”).

In one embodiment, formulation F and fertilizer N are applied to the soil by a device that is physically connected to a container comprising formulation F and to another container comprising fertilizer N, preferably in liquid form, especially preferably anhydrous ammonia, wherein formulation F and fertilizer N are applied to the soil simultaneously through separate nozzles (“co-injection”).

In one embodiment, formulation F and fertilizer N are applied to the soil after preparing a tank mix, meaning that a mixture of formulation F and fertilizer N, preferably in liquid form, especially preferably anhydrous ammonia, is prepared before its application. In this embodiment, formulation F and fertilizer N are applied by a device that does not continuously mix formulation F and fertilizer N but rather bears a tank comprising a readily prepared tank mix of formulation F and fertilizer N, preferably in liquid form, especially preferably anhydrous ammonia, that is than applied to the soil, for example by injection into the soil. In another embodiment, formulation F and fertilizer N are applied by a device that does not continuously mix formulation F and fertilizer N but rather bears a tank comprising a readily prepared tank mix of formulation F and fertilizer N, preferably in liquid form, especially preferably urea ammonium nitrate (UAN), that is than applied to the soil, for example by injection into the soil.

Normally, formulation F is applied to the soil such that nitrification inhibitor I is applied in an amount of 0.1 to 5% by weight based in fertilizer N.

In one embodiment, formulation F comprises DMP and propylene glycol and is applied to the soil in combination with anhydrous ammonia such that DMP is applied to the soil in an amount of 0.1 to 5% relative to the ammonia at the time of injection into the soil.

Preferably, methods according to the invention are carried out at a temperature below 20° C. more preferably below 10° C. Preferably, this is done in spring or fall season.

Normally, formulation F is applied to the soil in amounts (calculated as the nitrification inhibitor I) of 1 g to 100 kg per hectare, preferably 10 g to 10 kg per hectare and more preferably 50 g to 5 kg per hectare.

Another aspect of the present invention is the use of formulations F for fertilizing agricultural soil, wherein said formulation is applied to said soil in combination with at least one fertilizer N.

Another aspect of the present invention is a formulation F, said formulation comprising 5 to 50 parts by weight of 3,4-dimethyl-1H-pyrazole and 50 to 95 parts by weight of propylene glycol, wherein said formulation is essentially free from 3,4-dimethylpyrazolphosphate. Preferably, such formulations according to the invention comprise 20 to 45 parts of 3,4-dimethyl-1H-pyrazole and 55 to 80 parts by weight of propylene glycol. More preferably, such formulations according to the invention comprise 35 to 45 parts of 3,4-dimethyl-1H-pyrazole and 55 to 65 parts by weight of propylene glycol.

Formulations according to the invention can consist of the components described above or may further comprise additional additives as described above.

Another aspect of the present invention is a formulation comprising at least one nitrification inhibitor I and at least one organic solvent S, wherein said at least one solvent S is selected from ethylene glycol, propylene glycol, diethylene glycol, dipropylene glycol, diglyme, fatty acid dialkylamides, benzyl alcohol, butyrolactone or mixtures thereof, and further comprising anhydrous ammonia, wherein said formulation F is essentially free from 3,4-dimethylpyrazolphosphate.

Another aspect of the present invention is a formulation comprising 5 to 50 parts by weight of 3,4-dimethyl-1H-pyrazole and 50 to 95 parts by weight of propylene glycol and further comprising anhydrous ammonia wherein said formulation is essentially free from 3,4-dimethylpyrazolphosphate.

Another aspect of the present invention is a formulation comprising 35 to 45 parts by weight of 3,4-dimethyl-1H-pyrazole and 55 to 65 parts by weight of propylene glycol and further comprising anhydrous ammonia wherein said formulation is essentially free from 3,4-dimethylpyrazolphosphate.

Methods and formulations according to the invention can be used for growing a broad variety of crops, such as potatoes, sugar beets, wheat, barley, rye, oat, sorghum, rice, maize, cotton, rapeseed, oilseed rape, canola, soybeans, peas, field beans, sunflowers, sugar cane; cucumbers, tomatoes, onions, leeks, lettuce, squashes; corn, wheat, soy, cereals, row crops. Preferably, methods and formulations according to the invention are used for growing corn.

Methods and formulations according to the invention are easy and economical to prepare and to carry out and allow for the efficient fertilization of soil using a broad range of fertilizers. In particular, methods and formulations according to the invention allow for the efficient fertilization of soil using anhydrous ammonia as fertilizer.

Formulations F are very stable at high and low temperatures.

Formulations F are very stable at temperatures above 40° C. and below −10° C. over 24 h.

Formulations F can be mixed with anhydrous ammonia without formation of precipitate or solids.

Formulations F have a long shelf life at room temperature of more than 2 years.

Methods according to the invention can be carried even after formulations F have been exposed to temperatures above 40° C. and −20° C.

Methods according to the invention can be carried out in combination with anhydrous ammonia without the precipitation or formation of solids.

Methods and formulations according to the invention are compatible with a broad range of materials like plastics and metals. In particular, they show only little corrosion in combination with most metals like iron, steel, brass, aluminium, tin, zinc and copper.

### EXAMPLES

### Stability of Formulations F

DMP was used as a technical grade as a pure and undissolved substance.

### Example 1

40 parts by weight of DMP were mixed with 60 parts by weight of propylene glycol. A clear solution was obtained.

The so obtained solution could be mixed with anhydrous ammonia without the formation of any precipitate.

### Example 2

40 parts by weight of DMP were mixed with 10 parts of weight of propylene glycol and 50 parts of a 1:1 mixture of C₈- and C₁₀-fatty acid dimethylamide. A clear solution was obtained.

The so obtained solution could be mixed with anhydrous ammonia without the formation of any precipitate.

The formulations obtained in examples 1 and 2 were clear solutions that were stable over 24 hours at −10° C., −20° C. and −30° C. and were miscible with ammonia without the formation of precipitate.

### Comparative Example 3

A DMPP based formulation (72/8: DMP/H₃PO₄) was mixed with anhydrous ammonia. A cloudy precipitate was obtained.

### Comparative Example 4

The following formulation was prepared:

| Ingredient | ratio |
|---|---|
| DMPP | 7 |
| Benzyl alcohol | 2 |
| Propylene Glycol | 1.2 |
| Isopropyl amine (neutralize | 0.5 |
| pH to 7) | |
| total | 10.7 |

A clear solution was obtained.

Upon contact with anhydrous ammonia, a cloudy precipitate was formed.

### Example 5: Application of Formulations F to the Soil

The formulations from examples 1 and 2 (140 g/ha) and anhydrous ammonia (70% N) were co-injected into soil at a temperature below 20° C. Soil samples were collected to a depth of 12 inches centered on injection band. The soil was extracted and ammonium (NH₄⁺) amount was analyzed. It was found that with co-injection of DMP the ammonium (NH₄⁺) amount is much higher than the soil treated with the same amount of anhydrous ammonia without DMP.

### Comparative Example 6: Application of DMPP Formulation to Soil

Example 5 was carried out with DMPP obtained in Example 4. The formulation formed a solid and clogged the pumping and injection system.

### Example 7

40 parts by weight of DMP were mixed with 60 parts by weight of propylene glycol. A clear solution was obtained.

The so obtained solution could be mixed with UAN 32% N solution (solution of urea and ammonium nitrate in water with 32% N) without the formation of any precipitate.

TABLE 1
Tank mix compatibility data for Example 7

| | | Example 7 |
|---|---|---|
| Order of Addition | | First a), then b) |
| Composition | | a) Fertilizer 32% UAN |
| | | (57 Gal/A) |
| | | mixed with |
| | | b) Solution 1 (10 fl oz/A) = |
| | | Clear solution obtained by |
| | | mixing 40 parts by weight of |
| | | DMP with 60 parts by weight |
| | | of propylene glycol |
| Properties of the | Initial | Light Tan Clear |
| solution (tank mix) | 30 min stirring | Light Tan Clear |
| | 4 hours | Light Tan Clear |
| | 24 hours @ 5 C. | Light Tan Clear |
| | 15 min stirring | Light Tan Clear |

| | |
|---|---|
| pH | 8.32 |
| Result (tank mix compatibility) | Excellent |

1. A method for fertilizing agricultural soil comprising:
applying at least one fertilizer N to the soil, wherein the at least one fertilizer N is applied in combination with a formulation F, the formulation F comprising at least one nitrification inhibitor I and at least one organic solvent S, wherein the at least one nitrification inhibitor I is 3,4-dimethyl-1-H-pyrazole, and
wherein the at least one solvent S is selected from ethylene glycol, propylene glycol, diethylene glycol, dipropylene glycol, diglyme, fatty acid dialkylamides, benzyl alcohol, butyrolactone, propylene carbonate, ethyl hexyl lactate, 2-butoxy ethanol, dimethylsulfoxide and mixtures thereof, and
wherein the amount of 3,4-dimethylpyrazolphosphate in the formulation F is not more than 1 weight percent.

2. The method according to claim 1 wherein the fertilizer N is anhydrous ammonia or urea ammonium nitrate (UAN).

3. The method according to claim 1, wherein the solvent S is propylene glycol.

4. The method according to claim 1, wherein the formulation F comprises 5 to 50 parts by weight of the at least one nitrification inhibitor and 50 to 95 parts by weight of the solvent S.

5. The method according to claim 1, wherein the formulation F is mixed with anhydrous ammonia in a mixing chamber and the obtained mixture is applied to the soil.

6. The method according to claim 1, wherein the formulation F and anhydrous ammonia are applied to the soil through separate nozzles.

7. The method according to claim 1, wherein the formulation F and anhydrous ammonia are applied to the soil as a tank mix.

8. The method according to claim 1, wherein the formulation F is mixed with urea ammonium nitrate (UAN) in a mixing chamber and the obtained mixture is applied to the soil.

9. The method according to claim 1, wherein the formulation F and urea ammonium nitrate (UAN) are applied to the soil through separate nozzles.

10. The method according to claim 1, wherein the formulation F and urea ammonium nitrate (UAN) are applied to the soil as a tank mix.

11. A formulation comprising 5 to 50 parts by weight of 3,4-dimethyl-1H-pyrazole and 50 to 95 parts by weight of propylene glycol, wherein an amount of 3,4-dimethylpyrazolphosphate in said formulation is not more than 1 weight percent.

12. The formulation according to claim 11, further comprising anhydrous ammonia.

13. The formulation according to claim 11, further comprising urea ammonium nitrate (UAN).

14. A method of using the formulation according to claim 11, wherein the method comprises:
fertilizing agricultural soil, wherein the formulation is applied to the soil in combination with at least one fertilizer N.
